(19) United States
(12) Patent Application Publication
(10) Pub. No.: US 2007/0140317 A1
(43) Pub. Date: Jun. 21, 2007

(54) Differential phase modulated multi-band ultra-wideband communication system

(76) Inventor: Dagnachew Birru, Yorktown Heights, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/574,067

(22) PCT Filed: Sep. 29, 2004
(86) PCT No.: PCT/IB04/51919

§ 371 Date: Mar. 30, 2006

Related U.S. Application Data
(60) Provisional application No. 60/507,139, filed on Sep. 30, 2003.

(51) Int. Cl. H04B 1/00

(52) U.S. Cl. 375/130

(57) ABSTRACT

A method for conveying, a receiver for receiving and a signal that contains a differential phase modulated multi-band high-speed data stream are provided. A preferred embodiment is directed to a multi-band UWB signal where each band spans about 500 MHz to 1 GHz. Within each such band, a flexible modulation scheme of the present invention is employed that comprises two-pulse duplets having a difference set to π/2 or 90E. This modulation scheme allows adaptation of the data rate to the sub-band channel conditions. Within each band, time, amplitude and phase modulations are employed. In addition, a pseudorandom frequency sequence is employed to provide sufficient reduction of multi-user interference.

The present invention relates to an ultra wideband (UWB) communication system for wireless personal area networks (WPANs). More particularly, the present invention relates to a differential phase modulated multi-band UWB communication system for WPANs and its associated demodulation system.

Most of the implementations and research concerning UWB communication systems has been directed to low data rate applications. Such low data rate UWB systems are typically designed with low pulse repetition rates. As a result, the pulse amplitude and inter-pulse distance can be made high. This results in a well known benefit of UWB, namely, resilience to interference, such as multipath interference.

However, a UWB signal, as defined by the Federal Communications Commission (FCC), either has more than a 20% fractional bandwidth or occupies more than 500 MHz of spectrum, which means that a UWB signal doesn't need to be a very short impulse occupying the whole spectrum at the same time. A UWB signal can use multiple bands to encode information in parallel so that information is independent encoded in the different bands. This encoding process results in very high bit rate systems realized with relatively low signaling rates.

All systems are bound by channel capacity
C=Blog₂(1+S/N)
where
C=maximum channel capacity (bits/sec)
B=channel bandwidth (Hz)
S=signal power (watts)
N=noise power (watts)
   such that the upper bound on the capacity of a channel grows linearly with total available bandwidth B. Therefore, UWB systems, occupying 2 GHz or more, have greater room for expansion than systems that are more constrained by bandwidth and have great potential for support of future high-capacity wireless systems.

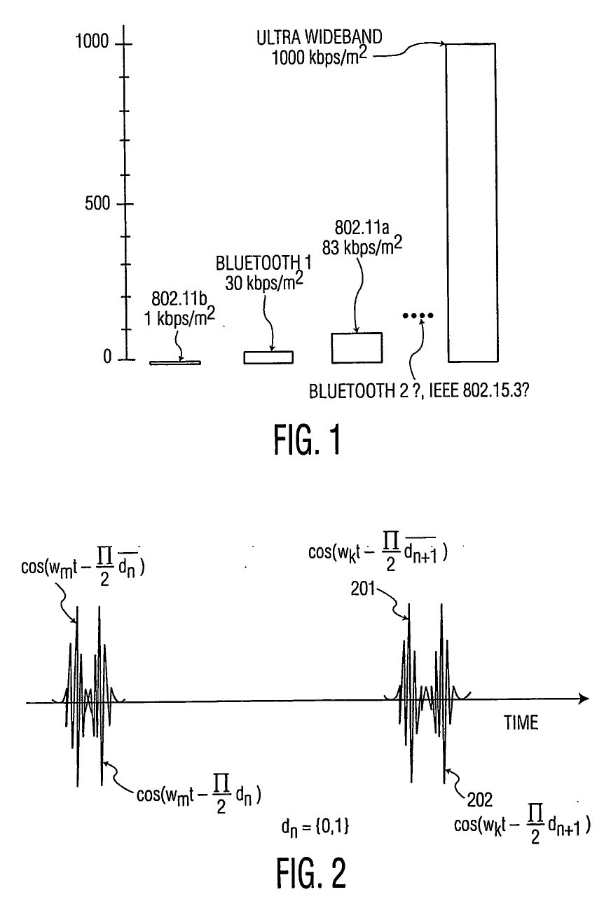

New applications of UWB technology, such as multimedia video distribution networks, require a high data rate system, e.g., 100 Mbps to 500 Mbps. One study compared IEEE 802.11b, Bluetooth, IEEE 80211a and UWB found that UWB spatial capacity exceeded all others by several orders of magnitude, see FIG. 1. However, conventional UWB techniques for achieving such a high data rate system are likely to require high pulse repetition rates, reducing the distance between successive pulses. This reduction results in conventional UWB systems that are prone to multipath interference.

In addition to supporting higher data rates, future UWB systems also need to be low cost if they are to complete favorably with narrow band systems. Given, that UWB receivers must be low cost, modulation techniques become the focus of study. The use of modulation techniques that require coherent receivers does not lead to low-cost implementations. The main reason for this is that coherent receivers require sophisticated circuitry (logic) in order to be able to generate local reference signals that are coherent in phase/frequency to the received waveform. In addition, the performance of such coherent receivers suffers from multipath/channel noise-induced phase mismatch.

A frequent design objective is that UWB modulation systems be demodulated with non-coherent receivers. Even though the theoretical performance of such no-coherent receivers is lower than that of their coherent counterparts, the performance of the practical implementations of the two receivers may be identical. In fact, in cases of heavy multipath interference, the con-coherent receivers may perform even better than their coherent counterparts without requiring additional phase/frequency or multipath mitigation circuits.

This use of WEB spectrum is not based on the traditional impulse radios, but on using multiple bands and has several other tangible benefits than those already discussed, including:
increased scalability and adaptability over single band designs;
better coexistence characteristics with systems such ad 802.11a; and
leverages more tradition radio design techniques thereby reducing implementation risk.

Further, the complexity and power consumption levels of single band designs can be maintained and while also achieving these advantages.

The present invention provides a phase modulated UWB signal, conveying method and receiver and in a preferred embodiment is directed to a multi-band UWB signal where each band spans about 500 MHz to 1 GHz. Within each such band, a flexible modulation scheme of the present invention is employed that comprises two-pulse duplets having a difference set to π/2 or 90E. This modulation scheme allows adaptation of the data rate to the sub-band channel conditions. Within each band, time, amplitude and phase modulations are employed. In addition, a pseudorandom frequency sequence is employed to provide sufficient reduction of multi-user interference.

FIG. 1 illustrates a spatial capacity comparison between IEEE 802.11, Bluetooth, and UWB.

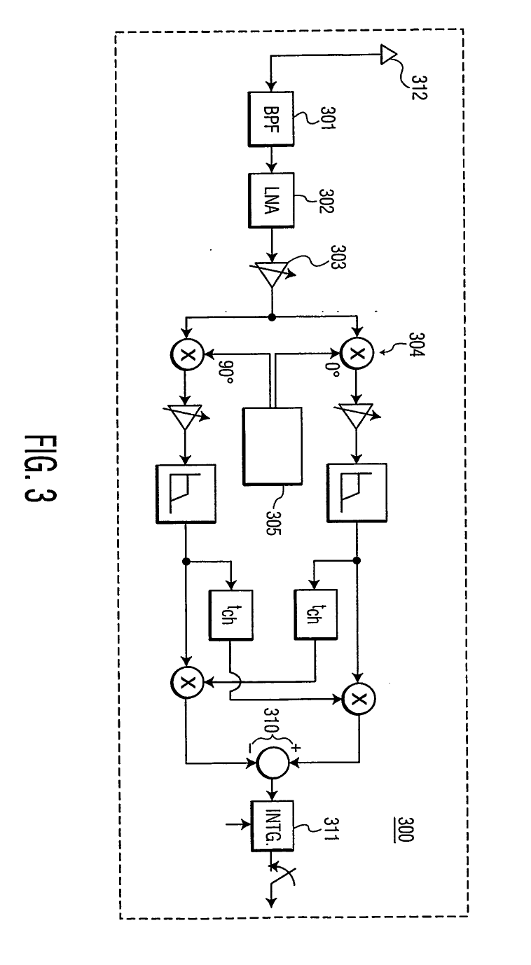

FIG. 2 is a typical signal waveform for π/2 differential phase UWB modulation.

FIG. 3 is a non-coherent (differentially coherent) receiver to demodulate a π/2 differential phase modulated multi-band UWB signal according to the present invention.

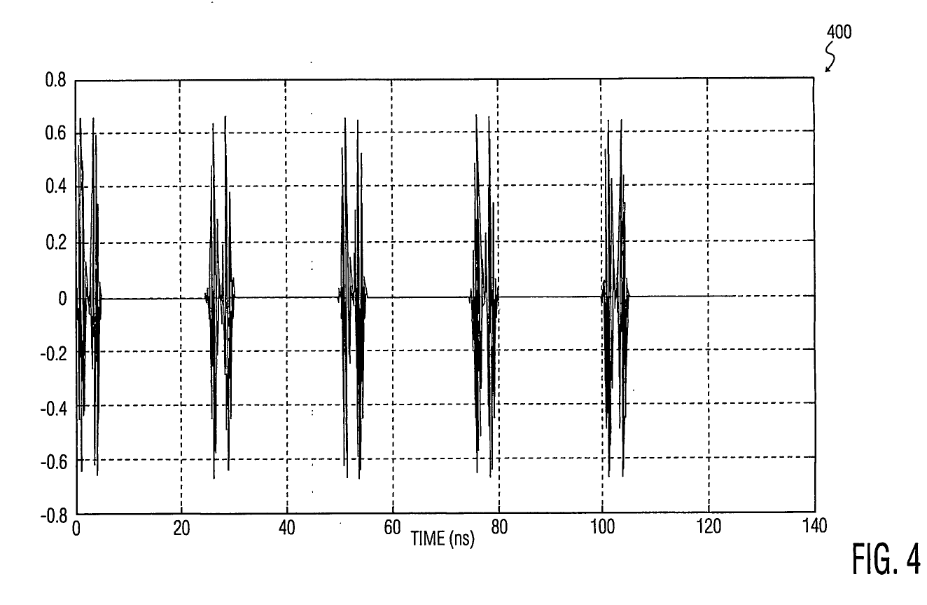

FIG. 4 is a typical emitted multi-band waveform in which each pulse pair has the same frequency.

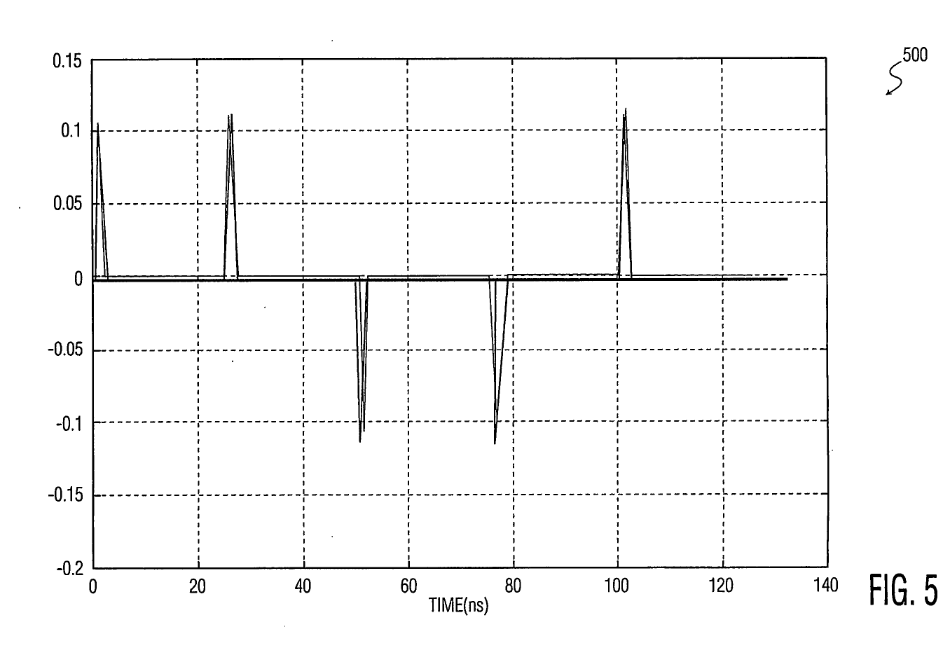

FIG. 5 is a demodulated waveform illustrating pulse trains with 1-bit per pulse in which combinations with PPM, according to the present invention, will produce more bits per pulse.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

In a preferred embodiment, the present invention provides a system and method for an ultra wideband communication system having multiple bands, i.e., a multi-band ultra-wideband communication system. Each of the bands spans 500 MHz to 1 GHz, approximately. A flexible modulation scheme is provided by the method of the present invention within each band.

For high-speed UWB applications, the modulation scheme of the present invention takes the form of duplets of pulses, i.e., pairs of pulses, for each bit transmitted. The phase difference between the first part of the pulse and the second part of the pulse is set to π/2 or 90°. FIG. 2 illustrates the modulation scheme of the present invention wherein in order to transmit a bit value of 1, for example when dₙ=1, a cos(wt) signal 201 is transmitted during a first sub-pulse time slot and then a sin(wt) signal 202 is transmitted during a second sub-pulse time slot. Transmission of bit 0 when dₙ=0 takes the form of transmission of sin(wt) during a first sub-pulse time slot followed by transmission of cos(wt) in a second sub-pulse time slot. This modulation scheme allows adaptation of the data rate to the sub-band channel conditions.

In a preferred embodiment, the modulation scheme of the present invention is combined with at least one of pulse position modulation and multi-band modulation. In the case of combination with a multi-band modulation scheme, the frequency of each pulse-duplet of a succession of pulse-duplets is different from that of the preceding or the following pulse-duplets of the succession. Such a multi-band transmission of pulses creates multiple bands of which each band utilizes π/2 modulation in combination with other modulation schemes. A primary advantage of this modulation scheme is simplicity of a non-coherent receiver implementation.

FIG. 3 illustrates a non-coherent demodulator according to a preferred embodiment of the present invention. This receiver is insensitive to phase and frequency mismatch between the received UWB waveform and the locally generated waveform. As a result, the locally generated waveforms (from the VCOs 305) can just be free-running. As a result, implementation is simplified.

In a preferred embodiment, the receiver illustrated in FIG. 3 is suitable for demodulation of a multi-band signal. In such a system the expected center frequency of the received waveform has to be known in advance. The frequency sequence of the received waveforms can be established during transmission of a preamble or via transmission of a known reference sequence for a short period of time. Once the frequency of the received waveform is known, the corresponding frequency from the local oscillators (e.g., VCOs 305) is fed to the first multiplier (mixer). This process down-converts the incoming signal into a signal that is centered at DC, provided that the local frequency is approximately equal to that of the received signal. After the first mixing, the subsequence processing and circuit elements are identical for all frequencies.

FIG. 4 illustrates a typical emitted waveform 400 (wherein each duplet has the same frequency) that is received by the receiver of FIG. 3 and then passed through a wideband band-pass filter (BPF) 301, followed with a low-noise amplifier (LNA) 302. The output of the LNA 302 is amplified/reduced to an appropriate level by the gain unit 303. The resulting signal is fed to the mixer 304. The mixer 304 multiplies the received waveform with the corresponding locally generated free-running sinusoidal waveform produced by the bank of Voltage Controlled Oscillators (VCOs) 305. The resulting mixed waveform is passed through a low-pass filter.

Further processing of this low-pass signal produces a single pulse for each bit transmitted via the phase of the signal. Additional bits per pulse can be transmitted by using pulse position modulation (PPM). FIG. 5 illustrates this further processed train of pulses. The demodulator converts the receiver's two-pulse duplets into a single pulse that is independent of frequency and phase mismatches. The sign 310 of the processed pulses corresponds to the transmitted data Further integration 311 and sampling produces the required bits.

In alternative preferred embodiments, in order to further mitigate multipath and other interference, this topology can be combined with one or more other receiver techniques, such as, a RAKE receiver and equalization.

The receiver and method of the present invention can be used for wireless personal area networks, for conveying video, audio, text, pictures, and data for controlling sensors, alarms, computers, audio-visual equipment, and entertainment systems. For example, the contents of a digital camera can be downloaded to a computer wirelessly.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt the teaching of the present invention to a particular situation without departing from its central scope. Therefore it is intended that the present invention not be limited to the particular embodiments disclosed as the best mode contemplated for carrying out the present invention, but that the present invention include all embodiments falling within the scope of the appended claims.

What is claimed is:

1. A method of conveying a high-speed digital data stream, comprising the steps of:
encoding the data stream into two-pulse duplets having a first and a second pulse for each bit of the data stream; and
transmitting a carrierless ultra wideband signal via an antenna, said ultra wideband signal including said duplets.

2. The method of claim 1, wherein said encoding step further comprises setting a phase difference between the first pulse and the second pulse to π/2.

3. The method of to claim 2, wherein said encoding step further comprises the steps of:
encoding a cos(wt) for a 1 bit during a first sub-pulse time slot and then a sin(wt) signal second sub-pulse time slot; and
encoding a sin(wt) during a first sub-pulse time and then a cos(wt) in a second sub-pulse time slot.

4. The method of claim 3, wherein:
said encoding step further comprises the steps of combining the encoding with at least one of pulse position modulation and multi-band modulation; and
within each band, employing at least one of time, amplitude and phase modulations.

5. The method of claim 4, further comprising the step of using a pseudorandom frequency sequence to provide sufficient reduction of multi-user interference.

6. The method of claim 2, further comprising the step of receiving said carrierless ultra wideband signal with a non-coherent receiver.

7. The method of claim 2, further comprising the step of decoding said high-speed digital data stream into a bit stream from said two-pulse duplets included in said received carrierless ultra wideband signal.

8. A high-speed digital data stream embodied in a carrierless ultra wideband signal including two-pulse duplets representing each bit of said data stream, comprising:
at least one data type selected from the group consisting of video, audio, text, image, and data; and
said two-pulse duplets each having a first pulse and a second pulse with a phase difference between the first pulse and the second pulse of π/2.

9. A high-speed digital data stream embodied in a carrierless ultra wideband signal according to claim 8, wherein said signal controls at least one device selected from the group consisting of video equipment, audio equipment, sensors, alarms, computers, audio-visual equipment, and entertainment systems.

10. A high-speed digital data stream embodied in a carrierless ultra wideband signal including two-pulse duplets representing each bit of said data stream, comprising network traffic to or from a wireless node of a network, wherein said two-pulse duplets each have a first pulse and a second pulse with a phase difference between the first pulse and the second pulse of π/2.

11. A non-coherent receiver, comprising:
an antenna that receives a carrierless ultra wideband signal conveyed using the method of claim 2 and that includes two-pulse duplets representing each bit of a high-speed digital data stream;
a wideband band-pass filter that filters the received signal;
a low-noise amplifier (LNA), coupled to said band-pass filter, that amplifies said filtered signal;
a gain unit that performs one of amplifying and reducing the signal output by the LNA to an appropriate level;
a bank of voltage controlled oscillators (VCOs) that locally generates a free-running sinusoidal waveform;
a mixer that multiplies the output of the gain unit with the sinusoidal waveform to result in a mixed waveform; a low pass filter through which the resulting mixed waveform is passed to produce a low-pass signal; and
a demodulator that converts each two-pulse duplet of the low-pass signal to a single pulse for each bit transmitted via the phase of the low-pass signal.

12. The receiver of claim 11, wherein said received signal further comprises additional bits per pulse that were encoded in the signal using pulse position modulation (PPM).

13. The receiver of claim 11, wherein the demodulator converts each two-pulse duplet into a single pulse that is independent of frequency and phase mismatches.

14. The receiver of claim 11, wherein:
said carrierless wideband signal is a multi-band signal;
an expected center frequency of the received carrierless wideband signal is known in advance; and
the frequency of the VCOs is set equal to that of the received carrierless wideband signal.

15. The receiver of claim 14, wherein the frequency sequence of the received carrierless wideband signal is established by transmission of one of (1) a preamble and (2) a known reference sequence for a short period of time.

16. The receiver of claim 15, further comprising at least one of a RAKE receiver and a receiver based on equalization that processes said received signal and outputs a signal that is combined with the output of the non-coherent signal to produce each bit of the high-speed data signal.
